(19) United States
(12) Patent Application Publication
(10) Pub. No.: US 2008/0166164 A1
(43) Pub. Date: Jul. 10, 2008

(54) IMAGE FORMING APPARATUS AND METHOD TO CONVEY PRINTING MEDIUM

(75) Inventor: Jeong Yeon PARK, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/966,030

(22) Filed: Dec. 28, 2007

(30) Foreign Application Priority Data
Jan. 4, 2007 (KR) 2007-1090
Feb. 23, 2007 (KR) 2007-18527

(51) Int. Cl. G03G 15/00

(52) U.S. Cl. 399/397

(57) ABSTRACT

An image forming apparatus includes an image forming apparatus body, a printing engine installed in the image forming apparatus body to print an image on a printing medium supplied to the printing engine, a printing medium supply device coupled to the image forming apparatus body to load the printing medium therein for supplying the printing medium to the printing engine, a pickup device to pick up the printing medium loaded in the printing medium supply device, a conveyance roller to convey the picked-up printing medium to the printing engine via rotation thereof, and a plurality of pressure rollers installed around the conveyance roller to press the printing medium in a normal direction of a surface of the conveyance roller during conveyance of the printing medium.

### CROSS-REFERENCE TO RELATED APPLICATIONS

This application claims the benefit under 35 U.S.C. §119(a) from Korean Patent Applications Nos. 2007-0018527 and 2007-0001090, filed on Feb. 23, 2007 and Jan. 4, 2007 in the Korean Intellectual Property Office, the disclosure of which is incorporated herein by reference.

### BACKGROUND OF THE INVENTION

1. Field of the Invention

The present invention relates to an image forming apparatus, and more particularly, to an image forming apparatus capable of stably conveying a printing medium to a printing engine, and a method of conveying a printing medium.

2. Description of the Related Art

Generally, an image forming apparatus is an apparatus to print a black-and-white image or color image on a printing medium, such as a sheet of paper, upon receiving an image signal. Examples of the image forming apparatus include a laser printer, ink-jet printer, copying machine, multi-functional machine, facsimile, etc. Representative image forming methods, employed in these various kinds of image forming apparatuses, include an electro-photographic method and an ink-jet method. In the electro-photographic method, a light beam is scanned onto a photosensitive member so as to form an electrostatic latent image, and a toner is attached onto the electrostatic latent image to transfer a toner image onto a printing medium. In the ink-jet method, liquid-phase ink is injected onto a surface of a printing medium on the basis of an image signal.

The above mentioned image forming apparatuses commonly comprise a printing medium supply device to store a plurality of printing media therein for the implementation of a sequential printing operation, a pickup device to pick up the printing media, loaded in the printing medium supply device, one by one, and a printing medium conveyance device to convey the picked-up printing medium to a printing engine.

To reduce the size of the image forming apparatus, conventionally, the printing medium supply device is installed below the printing engine, and the picked-up printing medium changes a movement direction thereof at least one time in the course of being conveyed to the printing engine. In this case, it is noted that the curvature of a direction change region of the printing medium has a great effect on the height of the image forming apparatus. For example, the greater the direction-change curvature of the printing medium, the greater the height of the image forming apparatus, whereas the smaller the direction-change curvature of the printing medium, the lesser the height of the image forming apparatus.

Recently, various attempts have been made to reduce the height of the image forming apparatus for the production of a compact image forming apparatus. As part of these efforts, various researches for developing a printing medium conveyance device having the small direction-change curvature of a printing medium have been ongoing.

In the development of the above described printing medium conveyance device, although the small direction-change curvature of a printing medium is effective to reduce the height of the image forming apparatus, it has problems of increasing the conveyance resistance of a printing medium and causing a slippage noise between a roller and a printing medium and the curl of the printing medium.

Therefore, in the development of the printing medium conveyance device, it should be noted to eliminate the above mentioned problems, for example, conveyance resistance, slippage noise, and curl of a printing medium while reducing a direction-change curvature of a printing medium.

### SUMMARY OF THE INVENTION

The present general inventive concept provides an image forming apparatus, which can reduce conveyance noise of a printing medium when a conveyance direction of the printing medium is changed toward a printing engine, and also, can guarantee stable conveyance of the printing medium without the risk of curl of the printing medium, and a method of conveying a printing medium.

Additional aspects and/or advantages of the general inventive concept will be set forth in part in the description which follows and, in part, will be obvious from the description, or may be learned by practice of the general inventive concept.

The foregoing and/or other aspects and utilities of the present general inventive concept can be achieved by providing an image forming apparatus including an image forming apparatus body, a printing engine installed in the image forming apparatus body to print an image on a printing medium supplied to the printing engine, a printing medium supply device coupled to the image forming apparatus body to load the printing medium therein to supply the printing medium to the printing engine, a pickup device to pick up the printing medium loaded in the printing medium supply device; a conveyance roller to convey the printing medium to the printing engine via rotation thereof, and a plurality of pressure rollers installed around the conveyance roller to press the printing medium in a normal direction of a surface of the conveyance roller during conveyance of the printing medium.

The image forming apparatus may further include at least one pressure spring to press the respective pressure rollers toward the center of the conveyance roller.

The at least one pressure spring may include a plurality of pressure springs to press the respective pressure rollers individually.

The plurality of pressure springs may press both ends of a supporting shaft of each pressure roller toward the conveyance roller.

The image forming apparatus may further include frames to support the respective pressure rollers and the respective pressure springs corresponding to the pressure rollers.

Both ends of each frame may be provided with a pair of shaft coupling portions to be coupled with both ends of the associated supporting shaft, and a pair of supporting ribs may be provided between the associated pressure roller and the shaft coupling portions to support the supporting shaft so as not to be moved in a circumferential direction of the conveyance roller.

Each shaft coupling portion may include a shaft coupling hole, into which the supporting shaft is inserted to be movable in a normal direction of the surface of the conveyance roller.

The pressure spring may press the plurality of pressure rollers at a time.

The pressure spring may be a semicircular leaf spring having an inner side to come into contact with the supporting shafts of the plurality of pressure rollers.

A foremost one of the plurality of pressure rollers on a printing medium conveyance path may be pressed toward the conveyance roller with a larger pressure force than the remaining pressure rollers.

The image forming apparatus may further include a tension roller to press the leaf spring to the foremost pressure roller.

The foregoing and/or other aspects and utilities of the present general inventive concept can also be achieved by providing an image forming apparatus including a printing medium supply device to load at least one sheet of printing medium, a pickup device to pick up the printing medium loaded in the printing medium supply device, a conveyance roller installed downstream of the pickup device on a printing medium conveyance path to convey the picked-up printing medium, and a first roller and a second roller installed to face the conveyance roller wherein the first roller closer to the pick up device than the second roller.

The first roller and the second roller installed to face the conveyance roller may be idle rollers.

The image forming apparatus may further include a printing engine to form an image on the printing medium, the conveyance roller being disposed between the pickup device and the printing engine.

The foregoing and/or other aspects and utilities of the present general inventive concept can be achieved by providing a method of conveying a printing medium of an image forming apparatus, the method including conveying a printing medium, which is picked up one by one, to a rotating conveyance roller, and pressing the printing medium, arrived at the conveyance roller, in a normal direction of a surface of the conveyance roller by use of a plurality of pressure rollers arranged around the conveyance roller along a rotating direction of the conveyance roller, to convey the pressed printing medium to a printing engine.

The foregoing and/or other aspects and utilities of the present general inventive concept may also be achieved by providing an image forming apparatus including a device disposed on a printing medium conveyance path to contact a first area of a printing medium to convey the printing medium, a conveyance roller disposed on the printing medium conveyance path to contact a second area of the printing medium greater than the first area to convey the printing medium, and a plurality of pressure rollers disposed around the second area to press the printing medium toward the conveyance roller.

The plurality of the pressure rollers may be arranged along the printing medium conveyance path to press the printing medium toward a rotation center of the conveyance roller.

The device may change the printing medium conveyance path at a first angle, and the conveyance roller changes the printing medium conveyance path at a second angle greater than the first angle.

The pressure rollers may include an aligning roller to align the printing medium with respect to the printing medium conveyance medium.

The foregoing and/or other aspects and utilities of the present general inventive concept may be achieved by providing an image forming apparatus including a device having a pair of rollers disposed opposite with respect to a printing medium conveyance path to convey a printing medium, and a conveyance roller and a plurality of pressure rollers disposed opposite with respect to the printing medium conveyance path to further convey the printing medium.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a side sectional view schematically illustrating an image forming apparatus according to an embodiment of the present general inventive concept;

FIG. 2 is a perspective view schematically illustrating a printing medium conveyance device of the image forming apparatus of FIG. 1;

FIG. 3 is an exploded perspective view illustrating a partial configuration of the printing medium conveyance device of FIG. 2;

FIG. 4 is an exploded perspective view illustrating a printing medium pressure device of the image forming apparatus of FIG. 1;

FIG. 5 is a side sectional view illustrating an operation of the printing medium conveyance device of FIG. 4;

FIG. 6 is a side sectional view schematically illustrating an image forming apparatus according to an embodiment of the present general inventive concept;

FIGS. 7 and 8 are a side view and a side sectional view, respectively, schematically illustrating a printing medium conveyance device general inventive concept of the image forming apparatus of FIG. 6;

FIG. 9 is a perspective view schematically illustrating a printing medium conveyance device usable with an image forming apparatus according to an embodiment of the present general inventive concept; and

FIG. 10 is a perspective view schematically illustrating a printing medium conveyance device usable with an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

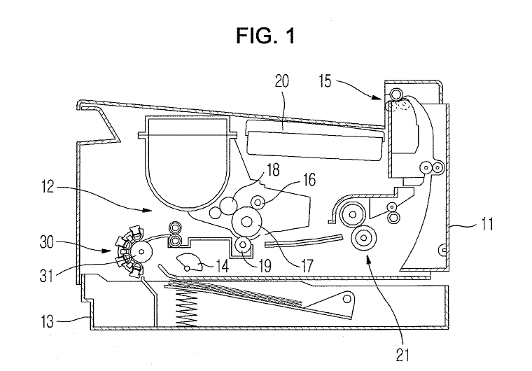

As illustrated in FIG. 1, the image forming apparatus according to the embodiment of the present general inventive concept is a laser printer in which a developing agent is attached onto a photosensitive member 17 formed with an electrostatic latent image to form a visible image, and the visible image is transferred onto a printing medium.

The image forming apparatus includes a body 11 defining an outer appearance of the image forming apparatus, a printing engine 12 to print an image on a printing medium supplied thereto, a printing medium supply device 13 detachably coupled to the image forming apparatus body 11 and configured to load a plurality of printing media therein to sequentially supply the printing media one by one, a pickup device 14 to pick up the printing media, loaded in the printing medium supply device 13, one by one, and a printing medium conveyance device 30 to convey the picked-up printing medium toward the printing engine 12.

In the image forming apparatus according to the present general inventive concept, the pickup device 14 is operated to pick up the printing media, loaded in the printing medium supply device 13, one by one, and to convey the printing media to the printing engine 12 in a printing operation. If the picked-up printing medium is conveyed to the printing engine 12 by the printing medium conveyance device 30, the printing medium is subjected to a printing operation, and thereafter, is discharged to the outside through a printing medium discharge region 15.

While the printing medium is picked up and conveyed to the printing engine 12, a light beam, which is scanned from an exposure unit 20 according to an image signal, is introduced onto a surface of a photosensitive member 17 that has been electrically charged with a predetermined electric potential by an electric charger 16, so as to form an electrostatic latent image on the surface of the photosensitive member 17. Then, as toner particles are attached to a region of the electrostatic latent image by a developing roller 18, a visible image in the form of powder is formed on the surface of the photosensitive member 17. The formed visible image is transferred onto a surface of each printing medium by a transfer device 19. Thereafter, the visible image, transferred onto the surface of the printing medium, is fixed onto the surface of the printing medium according to a pressure and heat of a fixing device 21 when the printing medium passes through the fixing device 21. The printing medium, having passed through the fixing device 21, is discharged to an outside of the image forming apparatus body 11 through the printing medium discharge region 15.

The above described image forming procedure can be performed sequentially, and the pickup device 14 and the printing medium conveyance device 30 are operated to sequentially supply the printing medium, loaded in the printing medium supply device 13, to the printing engine 12.

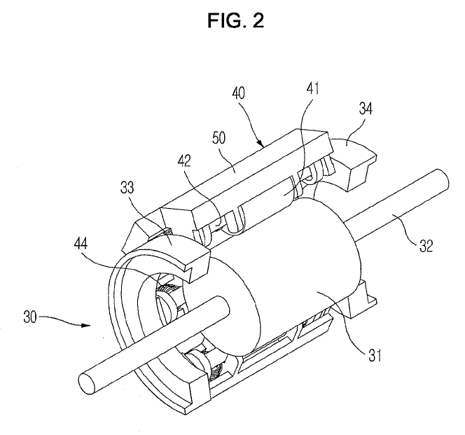

The printing medium conveyance device 30 serves to change a conveyance direction of the picked-up printing medium during conveying the printing medium, so as to convey the printing medium to the printing engine 12. The print medium is conveyed along a medium path formed between the print medium supply device 13 and the print medium conveyance device 30 in a direction, and between the print medium conveyance device 30 and the print engine 12 in a second direction, for example. The printing medium conveyance device 30, as illustrated in FIG. 2, includes a conveyance roller 31 to convey the picked-up printing medium by rotation thereof. A plurality of printing medium pressure devices 40 are provided on the printing medium conveyance device 30 to press the printing medium toward the conveyance roller 31 so as to allow the printing medium to come into close contact with a surface of the conveyance roller 31.

The pick-up device 14, the transfer device 19, and the fixing device 21 may change the conveyance path of the printing medium by a first angle between the downstream and upstream thereof, and the conveyance device 30 may change the conveyance path by a second angle greater than the first angle between the downstream and upstream thereof.

The conveyance roller 31 is supported on a roller shaft 32. If a drive force is applied to the roller shaft 32, the conveyance roller 31 is rotated in a predetermined direction together with the roller shaft 32. The conveyance roller 31 is arranged to come into contact with a surface of each printing medium, so as to convey the printing medium by use of a frictional force generated between the conveyance roller 31 and the printing medium.

The plurality of printing medium pressure devices 40 are arranged at a predetermined interval around the conveyance roller 31 along a rotating direction of the conveyance roller 31. Each printing medium pressure device 40 includes a pressure roller 41 to press each printing medium toward the conveyance roller 31, in a normal direction of the surface of the conveyance roller 31, a pair of pressure springs 44 to press the pressure roller 41 to the center of the conveyance roller 31, and a frame 50 to support the pressure roller 41 and the pressure springs 44.

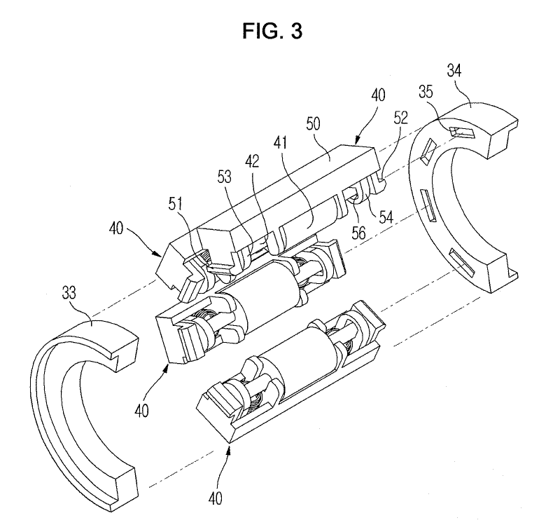

Referring to FIGS. 2 and 3, each printing medium pressure device 40 is coupled, at both ends thereof, to a pair of supporting members 33 and 34. Both ends of each frame 50 are provided with coupling protrusions 51 and 52, respectively, and the supporting members 33 and 34 have coupling recesses 35 corresponding to the respective coupling protrusions 51 and 52. As the respective coupling protrusions 51 and 52 of the frame 50 are fitted into the coupling recesses 35 of the supporting members 33 and 34, each frame 50 is coupled to the pair of supporting members 33 and 34. It is possible that the coupling protrusions 51 are formed on the supporting members 33 and 34, and that the coupling recesses 35 are formed on both ends of the frame 50.

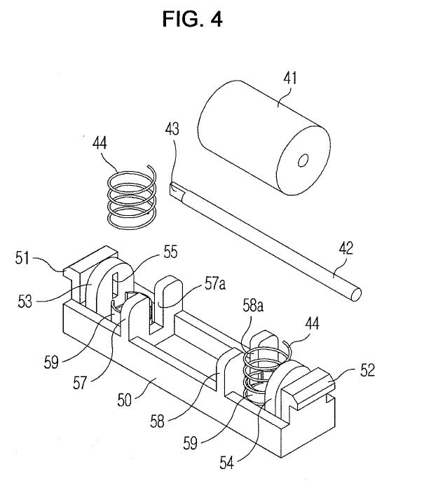

The pressure roller 41 is rotatably supported by a supporting shaft 42 fixed to the frame 50. The pressure roller 41 comes into contact with the conveyance roller 31, so as to be rotated by a frictional force caused between the pressure roller 41 and the conveyance roller 31. As illustrated in FIGS. 3 and 4, the frame 50 is provided, at both ends thereof, with a pair of shaft coupling portions 53 and 54 for the coupling of the supporting shaft 42. The shaft coupling portions 53 and 54 have shaft fixing holes 55 and 56, into which both ends of the supporting shaft 42 are inserted, respectively. At least one end of the supporting shaft 42 is provided with a rotation-preventing portion 43 to prevent rotation of the supporting shaft 42. The rotation-prevention portion 43 may have a cutout portion or a non-cylindrical shape different from a cylindrical shape of a center portion of the supporting shaft 42. The shaft fixing hole 55, into which the rotation-preventing portion 43 of the supporting shaft 42 will be inserted, has a shape corresponding to that of the rotation-preventing portion 43. The shaft fixing holes 55 and 56 have a length larger than a width of the supporting shaft 42, to allow the supporting shaft 42 to move toward the conveyance roller 31 along the shaft fixing holes 55 and 56.

A pair of supporting ribs 57 and 58 are formed on the frame 50 between the pair of shaft coupling portions 53 and 54 and used to prevent the supporting shaft 42 from moving in a circumferential direction of the conveyance roller 31. The supporting ribs 57 and 58 are spaced apart from each other such that the pressure roller 41 can be located between the supporting ribs 57 and 58. The supporting ribs 57 and 58 have supporting holes 57a and 58a having a width equal to or slightly larger than a width of a center portion of the supporting shaft 42. Although the supporting shaft 42 is movable in a normal direction of the conveyance roller 31 within the supporting holes 57a and 58a, the movement of the supporting shaft 42 is limited in a circumferential direction of the conveyance roller 31.

Spring mounts 59 for the coupling of the pressure springs 44 are provided, respectively, between the shaft coupling portion 53 of the frame 50 and the adjacent supporting rib 57 and between the shaft coupling portion 54 and the adjacent supporting rib 58. The pressure springs 44 may be a coil spring shape and are coupled to the respective spring mounts 59, the pressure springs 44 are installed at left and right sides of the pressure roller 41, respectively. Accordingly, once the supporting shaft 42, which was previously coupled with the pressure roller 41, is coupled to the frame 50, the respective pressure springs 44 press both the ends of the supporting shaft 42, which extend outward from left and right sides of the pressure roller 41, toward the conveyance roller 31, thereby allowing an overall surface of the pressure roller 41 to come into close contact with the surface of the conveyance roller 31 with a uniform force without deflection of the pressure roller 41 leftward or rightward.

Although the above described present embodiment illustrates and describes that four printing medium pressure devices 40 to press the printing medium in a normal direction of the conveyance roller 31 are coupled to the pair of supporting members 33 and 34, the number and interval of the printing medium pressure devices 40 can be changed in various manners on the basis of a conveyance path of the printing medium.

Hereinafter, an operation of the image forming apparatus and a method of conveying a printing medium according to the embodiment of the present general inventive concept will be described with reference to the accompanying drawings.

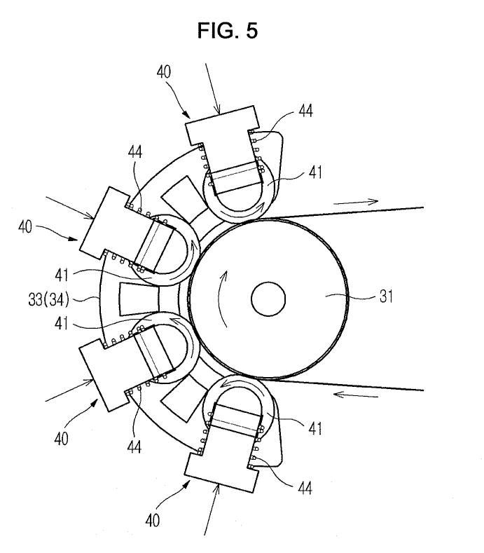

If a printing operation begins, as illustrated in FIG. 1, the pickup device 14 operates to pick up the printing media, loaded in the printing medium supply device 13, one by one, and the picked-up printing medium is conveyed to the printing medium conveyance device 30. The printing medium conveyed to the printing medium conveyance device 30, as illustrated in FIG. 5, passes between the conveyance roller 31, which rotates clockwise, and the plurality of pressure rollers 41, which rotate counterclockwise in contact with the conveyance roller 31.

In this case, the respective pressure rollers 41 are forced (or biased) to move toward the center of the conveyance roller 31 by the pressure springs 44, thereby pressing the printing medium in a normal direction of the surface of the conveyance roller 31 during conveying the printing medium. Thereby, while passing between the conveyance roller 31 and the respective pressure rollers 41, the printing medium comes into close contact with the surface of the conveyance roller 31, thereby stably conveying the printing medium to the printing engine 12 without slippage of the printing medium relative to the conveyance roller 31.

When a thickness of the printing medium being supplied is changed, the position of the pressure rollers 41 with respect to the conveyance roller 31 can be appropriately adjusted according to the thickness of the printing medium as the supporting shaft 42 moves forward and rearward along the respective shaft fitting holes 55 and 56 of the shaft coupling portions 53 and 54 upon receiving the elastic force of the pressure springs 44 and a repulsive force from the printing medium. Accordingly, when a thick printing medium is supplied, the supporting shaft 42 is moved away from the conveyance roller 31 such that no excessive repulsive force is applied to the pressure rollers 41 and the supporting shaft 42. Also, when a thin printing medium is supplied, the supporting shaft 42 is moved close to the conveyance roller 31, so as not to cause slippage between the printing medium and the conveyance roller 31.

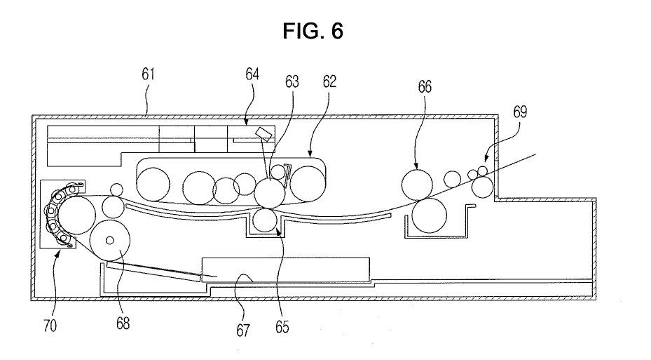

FIGS. 6 to 8 illustrate an image forming apparatus according to an embodiment of the present invention.

As illustrated in FIG. 6, the image forming apparatus according to the present embodiment includes a body 61 defining the outer appearance of the image forming apparatus, a printing engine 62 having a photosensitive member 63 therein to print an image on a printing medium supplied thereto, an exposure unit 64 to irradiate a light beam onto the photosensitive member 63, a transfer device 65 to transfer a visible image formed on the photosensitive member 63 onto the printing medium, a fixing device 66 to fix the visible image on the printing medium, a printing medium supply device 67 to load a plurality of printing media therein, a pickup device 68 to pick up the printing media, loaded in the printing medium supply device 67, one by one, a printing medium conveyance device 70 to convey the picked-up printing medium toward the printing engine 62, and a printing medium discharge device 69 to discharge the completely printed printing medium.

In the present embodiment, except for the printing medium conveyance device 70 the image forming apparatus of FIG. 6 are similar to those of the image forming apparatus of FIG. 1 and thus, a detailed description thereof will be omitted.

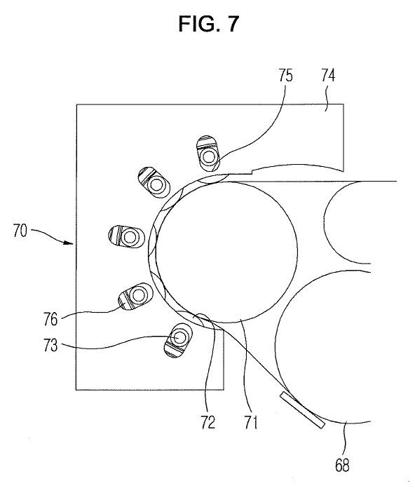

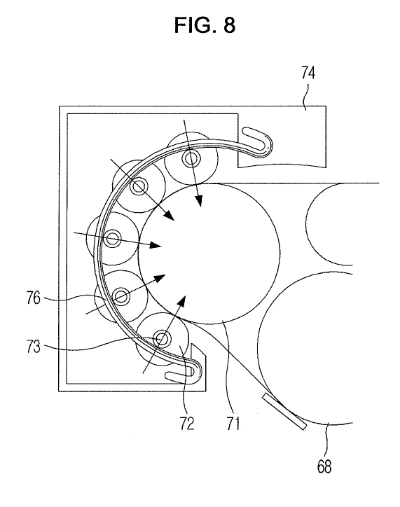

As illustrated in FIGS. 7 and 8, the printing medium conveyance device 70 includes a conveyance roller 71 to convey the picked-up printing medium, a plurality of pressure rollers 72 arranged around the conveyance roller 71 to come into contact with a surface of the conveyance roller 71, a supporting member 74 mounted on the body 61 to support the pressure rollers 72 such that the pressure rollers 72 are movable in a normal direction of the conveyance roller 71, and at least one pressure spring 76 to press the plurality of pressure rollers 72 toward the conveyance roller 71 at a time.

Each pressure roller 72 is an idle roller and is rotatably supported on a supporting shaft 73, which penetrates through the pressure roller 72 to protrude outward from both ends of the pressure roller 72. The supporting shaft 73 of each pressure roller 72 is supported by supporting holes 75 formed in opposite sides of the supporting member 74 such that the supporting shaft 73 is slightly movable in the supporting holes 75 in a normal direction of the conveyance roller 71. The supporting holes 75 have approximately the same width as an outer diameter of the supporting shaft 73, and are slightly elongated toward the center of the conveyance roller 71. With this configuration, each pressure roller 72 is limited in movement to a circumferential direction of the conveyance roller 71, but is movable in a normal direction of the conveyance roller 71.

The pressure spring 76 is a leaf spring having an inner side to come into contact with the respective supporting shafts 73 of the plurality of pressure rollers 72 at a predetermined interval, so as to press the plurality of pressure rollers 72 toward the center of the conveyance roller 71 at a time. One end of the pressure spring 76 is fixed to one side of the supporting member 74, and the other end of the pressure spring 76 is fixed to the other side of the supporting member 74. Alternatively, each pressure spring 76 may be installed at each end of the respective pressure rollers 72.

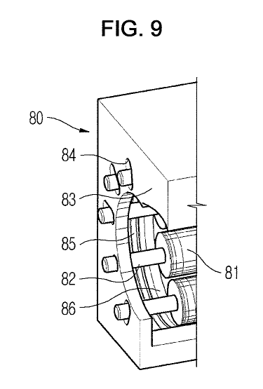

FIG. 9 illustrates a printing medium conveyance device 80 according to an embodiment of the present general inventive concept. Most of the configuration of the printing medium conveyance device 80 is similar to that of the printing medium conveyance device 70 of FIGS. 7 and 8. A difference between the printing medium conveyance devices 80 and 70 is that the printing medium conveyance device 80 of FIG. 9 includes ribs 86 installed in the supporting member 83 to limit leftward and rightward movements of a plurality of pressure rollers 81. The ribs 86 are installed at both ends of each pressure roller 81, respectively, such that they come into contact with both the ends of the pressure roller 81 to prevent leftward and rightward movements of the pressure rollers 81. Here, a supporting shaft 82 is disposed to support each pressure roller 81, a supporting hole 84 formed on the supporting member 83 to receive the supporting shaft 82, and a pressure spring 85 to press the supporting shafts 82 toward the conveyance roller 71 of FIGS. 7 and 8.

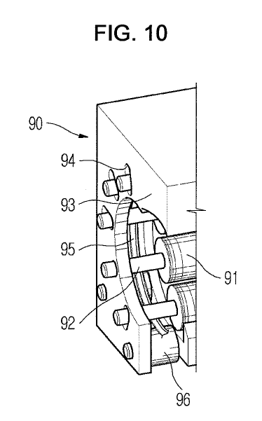

FIG. 10 illustrates a printing medium conveyance device 90 according to an embodiment of the present general inventive concept.

The printing medium conveyance device 90 of FIG. 10 includes a tension roller 96 to press at least one of the pressure rollers 91, which is located on a foremost position of a printing medium conveyance path, toward the conveyance roller (71, See FIG. 8). The tension roller 96 presses a part of a pressure spring 95 coming into contact with a supporting shaft 92 of the foremost pressure roller 91, to allow the foremost pressure roller 91 to come into contact with the conveyance roller 71 with a larger pressure force than the remaining pressure rollers 91. When the foremost pressure roller 91 is forcibly pressed onto the conveyance roller 71 by the tension roller 96, the printing medium can be aligned with respect to a printing medium conveyance path when it comes into contact with the foremost pressure roller 91 in the course of being transferred. Here, a supporting member 93 is disposed in a body, and a supporting hole 94 is formed on the supporting member 93 to receive the pressure shaft 92.

The foremost position of the printing medium conveyance path is a position where the printing medium enters the device 90. The foremost pressure roller 91 is pressed by a greater force than others.

Meanwhile, although a laser printer is exemplified as the image forming apparatus of the present general inventive concept in the above description, the present general inventive concept may employ other kinds of image forming apparatuses, such as an ink-jet printer, copying machine, multi-function machine, etc. except for the laser printer.

As apparent from the above description, according to the present general inventive concept, printing medium, which is picked up from the printing medium supply device, can be conveyed to the printing engine after being changed in a movement direction thereof with a small direction-change curvature. Such a small direction-change curvature of the printing medium has the effect of reducing the height of the image forming apparatus.

Further, according to the present general inventive concept, since a plurality of pressure rollers are used to press the printing medium in a normal direction of the surface of the conveyance roller in the course of conveying the printing medium, the printing medium comes into close contact with the surface of the conveyance roller during conveyance thereof, and the stable conveyance of the printing medium can be accomplished. Accordingly, during the conveyance of the printing medium, the present invention has the effects of reducing the generation of noise and preventing the curl of printing medium being conveyed.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An image forming apparatus comprising:
a printing medium supply device to load the printing medium therein;
a pickup device to pick up the printing medium loaded in the printing medium supply device;
a conveyance roller to convey the picked-up printing medium; and
a plurality of pressure rollers installed around the conveyance roller to press the printing medium in a normal direction of a surface of the conveyance roller during conveyance of the printing medium.

2. The image forming apparatus of claim 1, further comprising:
at least one pressure spring to press the respective pressure rollers toward the center of the conveyance roller.

3. The image forming apparatus of claim 2, wherein the at least one pressure spring comprises a plurality of pressure springs to press the respective pressure rollers individually.

4. The image forming apparatus of claim 3, wherein the plurality of pressure springs press both ends of a supporting shaft of each pressure roller toward the conveyance roller.

5. The image forming apparatus of claim 4, further comprising:
frames to support the respective pressure rollers and the respective pressure springs corresponding to the pressure rollers.

6. The image forming apparatus of claim 5, wherein both ends of each frame are provided with a pair of shaft coupling portions to be coupled with both ends of the associated supporting shaft, and a pair of supporting ribs are provided between the associated pressure roller and the shaft coupling portions to support the supporting shaft so as not to be moved in a circumferential direction of the conveyance roller.

7. The image forming apparatus of claim 6, wherein each shaft coupling portion comprises a shaft coupling hole, into which the supporting shaft is inserted to be movable in a normal direction of the surface of the conveyance roller.

8. The image forming apparatus of claim 2, wherein the pressure spring presses the plurality of pressure rollers at a time.

9. The image forming apparatus of claim 8, wherein the pressure spring is a semicircular leaf spring having an inner side to come into contact with the supporting shafts of the plurality of pressure rollers.

10. The image forming apparatus of claim 8, wherein a foremost one of the plurality of pressure rollers on a printing medium conveyance path is pressed toward the conveyance roller with a larger pressure force than the remaining pressure rollers.

11. The image forming apparatus of claim 1, further comprising:
a body; and
a printing engine installed in the body to print an image on the printing medium, wherein:
the conveyance roller to convey the picked-up printing medium with the pressure rollers toward the print engine;
the pressure rollers comprise a first roller and a second roller installed to face the conveyance roller, and
the first roller is disposed closer to the pick up device than the second roller.

12. The image forming apparatus of claim 11, further comprising:
a pressure spring to press the first roller and the second roller.

13. The image forming apparatus of claim 12, wherein a pressure force of the first roller and a pressure force of the second roller by the pressure spring are different each other.

14. The image forming apparatus of claim 13, wherein the pressure force of the first roller is larger than the pressure force of the second roller.

15. The image forming apparatus of claim 12, wherein the pressure spring comprises a plurality of pressure springs to press the first roller and the second roller respectively.

16. The image forming apparatus of claim 12, wherein the pressure spring is a semicircular leaf spring having an inner side to come into contact with a supporting shaft of the first roller and a supporting shaft of the second roller.

17. The image forming apparatus of claim 11, wherein the first roller and the second roller installed to face the conveyance roller are idle rollers.

18. The image forming apparatus of claim 17, further comprising:
a printing engine to form an image on the printing medium,
wherein the conveyance roller being disposed between the pickup device and the printing engine.

19. A method of conveying a printing medium of an image forming apparatus, the method comprising:
conveying a printing medium, which is picked up one by one, to a rotating conveyance roller; and
pressing the printing medium, arrived at the conveyance roller, in a normal direction of a surface of the conveyance roller by use of a plurality of pressure rollers arranged around the conveyance roller along a rotating direction of the conveyance roller, to convey the pressed printing medium to a printing engine.

20. An image forming apparatus comprising:
a device disposed on a printing medium conveyance path to contact a first area of a printing medium to convey the printing medium;
a conveyance roller disposed on the printing medium conveyance path to contact a second area of the printing medium greater than the first area to convey the printing medium; and
a plurality of pressure rollers disposed around the second area to press the printing medium toward the conveyance roller.

21. The image forming apparatus of claim 20, wherein the plurality of the pressure rollers are arranged along the printing medium conveyance path to press the printing medium toward a rotation center of the conveyance roller.

22. The image forming apparatus of claim 20, wherein the device changes the printing medium conveyance path at a first angle, and the conveyance roller changes the printing medium conveyance path at a second angle greater than the first angle.

23. An image forming apparatus comprising:
a device having a pair of rollers disposed opposite with respect to a printing medium conveyance path to convey a printing medium; and
a conveyance roller and a plurality of pressure rollers disposed opposite with respect to the printing medium conveyance path to further convey the printing medium.
